(19) United States
(12) Patent Application Publication
(10) Pub. No.: US 2013/0290089 A1
(43) Pub. Date: Oct. 31, 2013

(54) METHOD FOR INCREASING SHOP FOOT TRAFFIC WITH CUSTOMER REWARDS

(71) Applicants: Ari Bousbib, Waterbury, CT (US); Asher Baum, Brooklyn, NY (US)

(72) Inventors: Ari Bousbib, Waterbury, CT (US); Asher Baum, Brooklyn, NY (US)

(21) Appl. No.: 13/926,595

(22) Filed: Jun. 25, 2013

Related U.S. Application Data
(63) Continuation-in-part of application No. 13/726,365, filed on Dec. 24, 2012.
(60) Provisional application No. 61/579,855, filed on Dec. 23, 2011.
(60) Provisional application No. 61/615,883, filed on Mar. 26, 2012.

(51) Int. Cl. G06Q 30/02

(52) U.S. Cl. CPC G06Q 30/0226
USPC 705/14.27

(57) ABSTRACT

A method and system for increasing store foot traffic by providing customers with reward incentive. Retailers and customers sign up to the incentive program with an app being provided to the customer on a mobile device. The customer, when shopping at a first retailer is provided with a virtual coupon for related items at another proximate retailer, which is accessed such as with a tangible receipt, having a scannable unique notation. The customer scans the notation with a smart phone and with a downloaded rewards app operating to process it for the reward with the app effecting a transmission to a centralized and controlled server, with details of the sales transaction. The server analyzes the customer's purchase and provides a reward for determined related items at another proximate establishment valid for controlled times, and downloads it directly on the display of smart phone for scanning by a redeeming retailer.

### FIELD OF THE INVENTION

This invention relates to a method for increasing the foot traffic of shoppers in stores by providing customers in brick and mortar stores with reward coupons and vouchers for use in other local or proximate stores and particularly to such methods as used in conjunction with a smart phone app.

### BACKGROUND

The current trend with customer shopping has been the increasing prevalence of on-line purchases on the internet through on-line merchants or through marketing giants such as Amazon. Owners of “brick and mortar” stores have accordingly seen a substantial decrease in foot traffic and sales. In an effort to increase sales and counteract the corrosive effects of internet sales, stores have often opened their own web sites for internet sales and have attempted to provide customers with lures and incentives to return from on line purchases to in store purchases. However, marketing efforts such as Black Friday sales have had their limited success met with eroding influences of similar “Cyber Monday” on line sales with similar price reduction lures. On line organizations such as E-Bates and Groupon have also instituted various discounts to further provide on line customers with economic incentives to continue to shop.

### SUMMARY OF THE INVENTION

It is an object of the present invention to provide a customer incentive to shop in stores and thereby increase foot traffic.

It is a further object of the present invention to target customers already inclined to purchase in stores with a reward and incentive to continue to do so.

It is still yet another object of the present invention to provide such incentive with a controlled app.

Generally the present invention comprises a method and a system for increasing store foot traffic in vendor establishments by providing customers with an economic or reward incentive to enter the vendor establishments. The method comprises the steps of:
a) Setting up a system configured to interact with the vendor establishments and customers for the providing of economic or reward incentives to the customers for shopping in “brick and mortar” stores.
b) Vendor establishments being signed up to be part of a rewards program of the system, with the expectation of increased foot traffic thereby with increased in-store sales.
c) Customers being signed up to be part of the rewards program prior to, during or after an initial purchase or sales transaction at one of the vendor establishments, with the customer being provided with a coupon/rewards-providing app on a mobile device of the customer.
d) The app effecting a transmission to a centralized and controlled server of the system, with details of the sales transaction.
e) The customers being provided, by use of the app, with at least one virtual coupon for incentive pricing or rewards for related or linked type items or services, with a sales transaction at a first vendor establishment,
f) The system finding the physical location of the customer, which is provided to the system server, whereby the server of the system is configured to analyze the customer's sales transaction and provide the customer with a virtual coupon or reward benefit for determined commercially related or complementary items at another vendor establishment in proximity to the customers location, with the coupon or reward benefit being valid for controlled validity times.
g) Accessing, validating and redeeming of the virtual coupon or reward benefit by the customer being effected with the app provided by the system, with the virtual coupon or reward benefit being loaded on the customer's mobile device for the display thereon.
h) The virtual coupon or reward benefit being redeemed by a second vendor establishment.

In more detail, the present invention comprises a system and method for increasing store foot traffic by providing customers with an economic or reward incentive. In accordance with the present invention, stores, retailers or other actual “brick and mortar” vendors sign up to be part of the rewards program, with the expectation of increased foot traffic and sales and inexpensive focused advertising. Thereafter, a customer who has signed up for the incentive program of the present invention, and who is shopping at a first retail establishment, such as a store, is provided with one or more virtual coupons for related or linked type of items at another local proximate retail establishment.

The coupon is accessed via various data transactions such as with the use of credit/debit card or with the use of a print-out receipt or the like, having a scannable and unique notation or indicia such as a bar code on a sales receipt. The customer scans the notation or indicia with a smart phone or other mobile device (referred to herein for convenience as “smart phone”) equipped with a scanner and a downloaded transaction rewards app configured to operate with the present system. Use of a credit card for the transaction provides a similar operation with the system, provided that the credit/debit card is registered or identifiable within the system.

The app then effects a transmission to a centralized and controlled server or cloud based system, of the details of the sales transaction, e.g., name and location of the retailer and commercial category and possibly the type of purchased item and expenditure. The server or system then analyzes the customer's purchase and provides a reward coupon or voucher or other benefit (referred to herein as “coupon”) for determined commercially related or complementary items at another local establishment in convenient proximity to the customer. GPS tracking and the like, as currently commonly used on mobile devices such as smartphones, determines the physical location of the customer, for the issuance of the locally utilizable incentives or rewards which are valid for controlled validity times. Alternatively, or in addition, use of the credit card itself, in conjunction with a credit card reader used for the transaction, may similarly fix the requisite physical location of the credit card and thus of the customer.

Coupons or other indicia are generated for download directly on the display of a customers mobile device such as a smart phone and are scanned therefrom by the redeeming retailer and are optionally transferable, as desired. Redemption of the coupons is directly from the smart phone with scannable coupons on the smart phone. Smart phones or other mobile devices such as tablets, with displays of sufficient resolution, may be required to enable proper scanning by the redeeming retailer.

It is understood that the barcodes, receipts and credit card transaction operations are simply illustrative of the operational aspects of the system but are not limiting with respect to elements used with the transactional rewards app. Ideally, the barcode or indicia should be printed on customer receipt. However, each store has to program barcode into their receipt machine and this may be difficult to implement. Accordingly, preset barcodes or similar retail and transaction identification may be generically generated for use by the signed up retail establishments. In this aspect, in a preferred embodiment, each requesting and participating store is issued a generic, and adapted special barcode for that specific retailer. This serves to identify the store (and store category), which the customer patronized so that new benefits are issued in different categories, and will also determine how much was spent in the store. In a non-limiting embodiment it is thereby possible to tailor the reward to expenditure. Thus, depending on how much was spent in the original store, discounts in the next store will be appropriately determined. For example, if $100 is spent by a customer in a first store, the customer may receive 10% off at other retailers, whereas, if $200 is initially spent, 20% off may be rewarded for use with other retail stores. Credit card transactions within the system are similarly logged in to provide the requisite coupons

Other objects, features and advantages of the present invention will become more evident from the following discussion and drawings in which:

### SHORT DESCRIPTION OF THE DRAWINGS

FIGS. 1-3 are smart phone screen shots depicting generation and redemption of purchase benefits or coupons according to the present invention.

FIGS. 4 and 5 are processing flow charts of point of sale and app logic respectively depicting operation of embodiments of the present invention.

### DETAILED DESCRIPTION OF THE INVENTION

In order to illustrate the operation of the present rewards system the following non-limiting scenario depicts how a customer is rewarded with purchases in retail establishments, which have signed up with the system program. It is noted that “retail” is exemplary of typical stores but is not a limiting description.

In a typical operational transaction:

A customer shops at a retailer and, for example, purchases clothing (the store being classified as being in the apparel category), and at the check-out counter the cashier rings up the sale and generates a purchase receipt which, as with transactions generally, is given to the customer. On the receipt there is a generated barcode that recognizes the transaction rewards app developed as described for coupon generation. The app is activated when the customer scans the barcode on the receipt with a scanner on the phone (usually utilizing the smart phone camera) and details of the transaction (e.g., store, location, store category, type of item and amount of payment made). If the customer is already signed up with the system, with the app being available at no charge, and the app is opened, a menu opens up with various category “benefits” for use with other retailers. A benefit or reward is saved in the “my barcode benefits” folder for a predetermined time period such as an extended period of up to 10 days. Other benefits may be more time restricted such as when the system determines that the customer is in a mall and amenable to purchases in other nearby stores. In this instance the benefit may be restricted to being redeemed on that day and expire in 24 hours. This encourages impulsive purchases to use them up before expiration by shopping at additional stores.

When the customer is ready to purchase an item in the “next store” with the benefit promotion, the “benefit” now saved in the “barcode benefits” folder is accessed on the smart phone and the phone is handed over to cashier at the next store for direct scanning of the coupon on the phone for the customer to receive the discount. No paper coupons are generated and the redemption is electronically logged and accurately completed. The central app controlling company remains in control over all benefits and also knows when to terminate benefits when they expire.

In order to enhance a social aspect of the system, making the system more acceptable to customers, it is preferred to allow customers to “gift” a received benefit to a friend. This results in the rewards program becoming more “viral” and allows the overall store foot traffic user base to expand. For example, someone signed up to the transaction reward app will receive message that “a friend gifted a benefit to you”. Someone who hasn't signed up yet to the system or app will receive an email, provided to the server or cloud system, that “a friend wants to give you a thoughtful gift”, and will be provided a link to the sign-up page.

The transaction reward app should preferably be able to collect information regarding customer spending habits and shopping preferences, according to the purchase transactions, as provided to the central server, via the app. This enables the customers to be allocated benefits in a more focused manner. With permission, the information collected may also be used in focus groups and the like.

In a further preferred embodiment, when a customer clicks on a benefit, either a text or voice message is provided to inform the customer, who has already patronized a retailer, what that particular retailer is offering as its “deals of the day”. From the retailer's point of view this is an inexpensive and highly targeted advertising method. The retailer information is constantly uploaded by the retailer to the server or cloud, which, in turn, broadcasts it to the customer. To avoid intrusiveness and annoyance, the customer should be provided with the ability to turn off these notifications.

The following is an outline of requirements and desirable optional characteristics of the controlling app designated herein as “BarCode”:

Overall Architecture, High Level Components:
a. Business logic resides on centralized servers or “BarCode Cloud”
b. Retailers interface to the BarCode Cloud
c. Customer app on mobile devices connect to the Cloud

Lower Level Components of the app:
a. Location based on device GPS
b. Barcode scanner
c. Easy to use interface
d. Coupon display, barcode to be scanned by retailers

Utilized Code:

Code is configured to take data from retailers and customers and uses proprietary algorithms to distribute coupons based on:
a. Location of customer
b. User history of purchases
c. Retailer affiliations, competing retailers
d. Success probability

Data Warehouse:
Houses all customer activity for further analysis.

The data includes:
User's shopping patterns,
Analysis of campaigns' success levels (which coupons work best, when etc.),
Location based statistics (which geographic location does better than others etc.)

Use Characteristics:
The system has high availability, to avoid risk of downtime when shoppers expect a coupon.
The system includes security features since sensitive personal information is stored on the servers.
The system has standard interfaces for a wide variety of retailer system integration.

Retailer Side:
Retailers are given the parameters to generate a bar code (or other indicia) based on the following criteria:
a. Code given for the retailer, and a range of the dollar amount spent at that retailer. The algorithm is integrated to the retailers process and the bar code, which is printed on the receipt
b. Most retailers have a barcode on their receipts, this is scanned, with the retailer posting basic data to the BarCode cloud, as a part of the data capture. The information includes the barcode on the receipt, the retailer code, and the purchase amount. This gets posted real time to the Barcode cloud and is immediately processed to provide the data needed to process the coupon generation.
c. Credit Card/Store Card Payments Direct Integration: Retailer will post, in real time, the name from the card as well as the last 4 digits of the payment method credit/debit card to the cloud. (In order to protect users privacy, stores can hash this data with a public algorithm such as SHA1 instead.) This information is matched to the system database with a follow-up coupon being “pushed” immediately to the user's smartphone.
d. Credit Card Payments Indirect Integration: Retailers will approve their merchant services, such as Authorize.net, to post sales data to the BarCode cloud. These merchant services will integrate with BarCode on the behalf of all their clients, allowing a seamless integration without any changes needed to the Retailers Point of Sale Software.

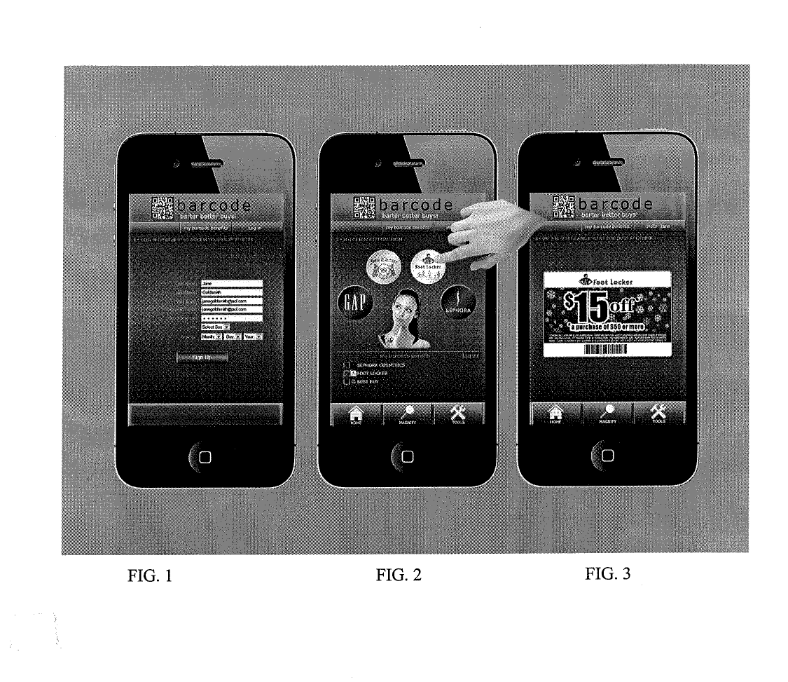

FIGS. 1-3 depict a typical customer transaction with FIG. 1 depicting the initial transaction, FIG. 2 depicting menu selection and FIG. 3 depicting coupon generation for scanning and redemption.

Retailers join the Barcode platform by agreeing to provide discounts to the Barcode subscribers. Each retailer is placed in a category (or multiple categories, if applicable) that allows Barcode to offer to its subscribers discounts as options after each retail purchase.

Retailers then provide the details of the discounts they are willing to provide. There needs to be minimums in place or the size of the discount can be used as a “bid” for the consumer's attention, that is, the user might be presented with the biggest (non-conflicting) discount in a particular category. This will incentivize the retailers to give more substantial discounts which makes the program more attractive to the consumer.

The retailers may provide four levels of discounts:
1) Discount if they are the first destination of choice (around 5% level)
2) Discount if they are being offered as a follow up purchase coupon (obviously needs to be more significant in order to “pull” the consumer in to their store after their initial targeted purchase.
3) General discount available whether they are the first destination or a follow up purchase. This is particularly favorable for food vendors and other small vendors that don't expect to draw clients otherwise.

Retailers will decide a percentage of times that their coupon would be displayed at all. This allows retailers to limit their coupons so users can't assume they will always have a discount and thus not be used by regular shoppers. It will also serve to draw the user to shop immediately.

Included are discounts for food vendors, and it may be necessary to deal with these and similar categories slightly differently. These vendors are solely dependent on foot traffic for their business and as such would gain the most by Barcode generated foot traffic. Consumer side of the business logic:

Consumer signs up to Barcode:
1) Directly on barcode web site
2) Via invitation from friend
3) Via promotion from retailer
4) Via promotion from mall/real estate owner

During the setup process, the users are asked to enter their email address, password, gender. They can also fill out their birthday and/or anniversary for special promotions on these days.

The users is also be prompted to provide the full name and last four digits of their credit card(s) and/or store cards in order to link such purchases to the providing of the benefits. This information is securely hashed for comparison reasons only and will not be saved in any readable format, to avoid any privacy issues. They may have the ability to enter up to 100 such cards.

The benefit delivery is preferably via a smart phone app or alternatively via a tablet or other mobile device amenable to being carried into stores.

When planning a trip to the mall, the user checks the app for the retailer of first choice and sees if there are any coupons available. This coupon is of the first type (about 5%) of coupons the retailers make available. The coupon is generated on the iPhone or other type of smart phone, tablet and the like, for use during that store visit that day. It is only valid for that day.

At check-out, the shoppers presents the coupon on the iPhone (or other smart phone or mobile device) as they would any other coupon. The receipt of the participating retailer now produces the “barcode” based on the retailer's given id and the purchase amount. These are the only data points required from the receipt, as it is important for Barcode to stay clear of data privacy issues of the retailer. In fact there is no requirement that the exact purchase amount be known but rather a purchase within a predefined range be set. (For example: Under 100, between 100 and 200, etc.)

The shopper than scans this barcode on the receipt using the Barcode app. This is sent to the Barcode cloud for immediate analysis and the shopper is presented with a set of offers from other categories of retailers within that shopping location. Shoppers can then choose which of these offers they would like to take advantage of and proceed to the next retailer for the discount.

There are some rules here that make this a “game” or an “auction” of sorts:

The buyer must make a choice of one out of all the offers. This presents the retailers the incentive to provide deeper discounts to win the traffic.
The buyer can choose to keep an additional item for future use. This provides a way to keep the buyers engaged.
There are categories like food vendors and other impulse buys that are not necessarily restricted by the buyer's choice.
Once the business rules and logic are specified, it is possible to then proceed with implementing them.
Implementation Facets:
1. Overall Architecture Components:
   a. Business logic resides on centralized servers, “BarCode Cloud”
   b. Retailers interface to the BarCode Cloud—
   c. Consumer app on mobile devices connect to the Cloud
2. App Components:
   a. Location based on device GPS or credit card use-location fixing
   b. Barcode scanner
   c. Easy to use interface
   d. Coupon display, barcode to be scanned by retailers
3. Bar-Code Cloud Parameters:

This code takes data from retailers and consumers and uses proprietary algorithms to distribute coupons based on:
a. Location of consumer
b. User history of purchases
c. Retailer affiliations, competing retailers
d. Success probability
This will also house a data warehouse of all consumer activity for further analysis. The data will include: user's shopping patterns, analysis of campaigns' success levels (which coupons work best, when etc.), location based statistics (which geographic location does better than others etc.) The data and the resulting analytics can be as valuable as the coupon side of the business.

Considerations for the System:

Preferred features of the system include
High availability as a highly preferred state, since the system should not risk downtime when shoppers expect a coupon;
Security; with sensitive personal information being stored on the servers; and
Standard interfaces for a wide variety of retailer system integration.

The hosting requirements for the barcode cloud do not have to be as significant as other social media platforms as the requests and the resulting responses (coupons) are small sets of data and can scale significantly with greater ease and less onerous hardware costs.

4. Retailer Link:

As described above, this requires retail POS system integration in the most efficient manner. Some potential ways to work with retailers, (though the ultimate way should be determined based on expert input) include:
a. Retailers are given the parameters to generate a bar code based on the following criteria: a code given for the retailer, and a range of the dollar amount spent at that retailer. The algorithm should be easy to integrate to the retailers process and the bar code can be printed on the receipt based the code generated.
b. Most retailers have a barcode on their receipt, and it is possible to scan that bar code, and have the retailer post basic data to the BarCode cloud as a part of the data capture. The information needs to include the barcode on the receipt, the retailer code, and the purchase amount. This gets posted real time to the Barcode cloud and is immediately processed to provide the data needed to process the coupon generation.
c. Credit Card/Store Card Payments Direct Integration: Retailer will post, in real time, the name from the card as well as the last 4 digits of the payment method to the cloud. (In order to protect users privacy, stores can hash this data with a public algorithm such as SHA1 instead.) This information is matched to the system database and a follow-up coupon is pushed immediately to the user's smartphone.
d. Credit Card Payments Indirect Integration: Retailers are able to approve their merchant services, such as Authorize.net, to post sales data to the BarCode cloud. These merchant services integrate with BarCode on the behalf of all their clients, allowing a seamless integration without any changes needed to the Retailers Point of Sale Software.

### Business Rules for System Operation:

1—The cloud recognizes the app's location via GPS tracking and knows the retailers in that particular mall and is able to best assist or issue the benefits from that mall and or nearby locations. Not all malls are indoor malls. For instance, many malls have massive collections of many box-like retailers such as Home Depot. or Sears or even Nordstrom, that need to be entered from the outside. This needs to be accounted for as well.

This should be just a matter of distance-based calculation. With an address database of retailers there should preferably be a single source of this data that can easily be obtained. However it can also be put together from disparate lists of retailers. This database provides a list of “available” (understood as being within a walking distance or within the same mall) stores for the categories that are presented.

### Retailer Structures Needed:

Master database of retailers includes: retailer name, category, retailer code,

Retailer Locations: retailer code, address (as detailed as possible) many to one connection to the Master database. There may also preferably be an option to override the category for this particular store, so a limited store branch can be categorized correctly.

2—It is preferred to encourage not only foot-traffic from retailer to retailer, but also throughout the mall. Thus, if someone is shopping in Macy's and right next door to Macy's is Finishline (a sneaker retailer), the system is not necessarily limited, with the “cloud” to issue a benefit to the store next door, but may also or instead send the traffic to Footlocker that may be a floor above them, in order to legitimately increase mall foot traffic.

A function of presenting the retailer with the highest probability of closing a sale include factors of:

1. Size of the discount the retailers are “bidding”, for the consumer's attention. Size of the discount can be based on average or median sales versus the size of the discount, so if median transaction is $50 and coupon is $10 off $30, this will be weighed as being similar to a 20% off coupon.

2. History of the consumer with past purchases.

3. Seasonal consideration (e.g., back to school might favor certain retailers over others)

4. Distance (the closer the store the more impulse buy opportunity there is)

5. Time of day (e.g., if it is late in the day the proposed store should be closer and perhaps smaller to avoid overwhelming a tired consumer).

The cloud will preferably automatically upload to the app a series of categories (with the number of categories being predetermined and the types of retailers that fall into specific categories).

Categories (with typical merchants), for example, include:
Footwear—(Footlocker, Finishline . . . )
Home Improvement—(Home Depot, Kohls . . . )
Department Store—(Nordstrom, Macy's . . . )
Electronics—(Best buy, Radio Shack . . . )
Woman's Category—(Sephora, Victoria Secret . . . )
Toys/Gaming—Toys'rUs
Restaurant—(McDonald's, Applebees, Burger King . . . )
Jewelry—this category is for both male and female. Men/boyfriends often purchase jewelry for the spouse/girlfriends.
Sporting goods—Sport's Authority, Dick's Sporting Goods, Modell's
Clothing—Brooks Brothers, Burberry
   Other retailers of less determinative categorization include
Sears—a combo retailer that mixes home improvement with regular shopping and is a hybrid department and home improvement retailer

Though it may be possible for an app use to provide 10-15 categories, it is preferable for an app to only release 6 categories at most at a time to provide a cleaner more focused and consumer friendly interface, with a next purchase at the next retailer, possibly providing additional categories.

This will allow a customer to cover and/or concentrate on what is now in hand. It is additionally preferable that certain categories will always come up such as for a woman, i.e., the woman's specialty category . . . Or for a man, perhaps a sporting goods category will always come up as well. Some department stores have specialized stores geared towards garments or men or furniture. A coupon based on location should reflect the individual retailer within the same mall area.

It is preferable to select one of the categories and save it the barcode benefits folder for up to 10 days. Logic dictates that with picking a coupon (e.g., for Radio Shack) it may be to save it for another day. Once a coupon is saved it should be treated the same as if the coupon had been redeemed and any follow-up coupons would be removed. Thus, if another first destination is selected coupon (e.g. for Footlocker), the saved coupon will become void.

The cloud may be configured to operate like a “circular”. Thus, assuming the receiving of a GAP benefit, when the benefit “button” is pressed on the screen it will bring up deals of the day at GAP, or whatever retailer benefit are available to receive. This provides encouragement to visit all sections of the store and/or be a “smarter shopper” knowing what's on sale before a purchase and is uploaded by the retailer to the cloud on a daily or weekly basis.

In order to purchase something at a store, “my barcode benefit's” folder in the app is activated, with select benefit to use. A benefit is selected to be scanned by a cashier and to receive discounts for the next retailer that's proportionate to the money spent at the current store. For example, a general percentage such as 5% may be offered off in all barcode participating retailers for barcode members that they will be able to access to encourage a first purchase in any store before obtaining the separate reward based on purchase.

In order to prevent abuse of purchases being made to obtain for example a 30% discount at a footwear store by a prior purchase in another store and then returning the original merchandise the system should be configured to be able to seek out these abusers and suspend the account for a period of time. A purchaser's shopping pattern can then be recognized and if the purchaser is a recidivist, the system account is automatically closed.

Barcode members may preferably actively engage with other members. Thus, “Jessica” could “gift” her friend, “Jane” a benefit, in which case the benefit transfers to Jane's account. It is highly preferable that there is a countdown clock, in the status column, letting users know when specific benefits are set to expire.

Integration with systems such as Facebook, Twitter and the like highly preferable as well, to permit customer to gift benefits to their friends. Users are preferably able to share a coupon they are presented with their friends using email or social media. These coupons are different in that they will have longer expiration dates and limited uses. This limit is across all users as defined by the retailer, so a coupon can technically be shared repeatedly and by the recipients, but only while it lasts.

In addition to the above, credits or points may be awarded to a consumer who simply stays at a retailer for a certain period of time. This can be monitored from GPS By gifting benefit to friend the coupon can lose value over period of time until it expires. This pushes recipients to use the coupon as soon as possible.

Advertising is an option such as when someone opens app a flash screen appears of a retailer or a promotion at a retailer.

The “process” of the present invention is preferably made open to the retailers via a web portal, where the retailer, no matter how little or large, can sign up for the program and offer coupons. The web portal shows retailers the potential consumers at any given location that are scanning the barcodes and the retailers can determine the “bid” or the size of the offer the retailers are willing to provide. This allows smaller retailers to take advantage of mall anchor retailers' promotions and foot traffic. Similarly, this allows all retailers to participate similar to akin to Google's “Adwords” concept but as modified and applied to brick and mortar stores.

Consumer are allowed to scroll through all the offers in order of presenting the highest odds of success. The barcode cloud is able to restrict the coupons to one retailer per category other than the specialty stores.

In a further preferred embodiment the number of potential customers within proximity of a vendor establishment are determined by the physical location determination of the system. This number is made accessible to the vendor establishments, with the vendor establishments being provided with the capability of modifying available number and size of virtual coupon discounts based on the number of provided number of potential customers.

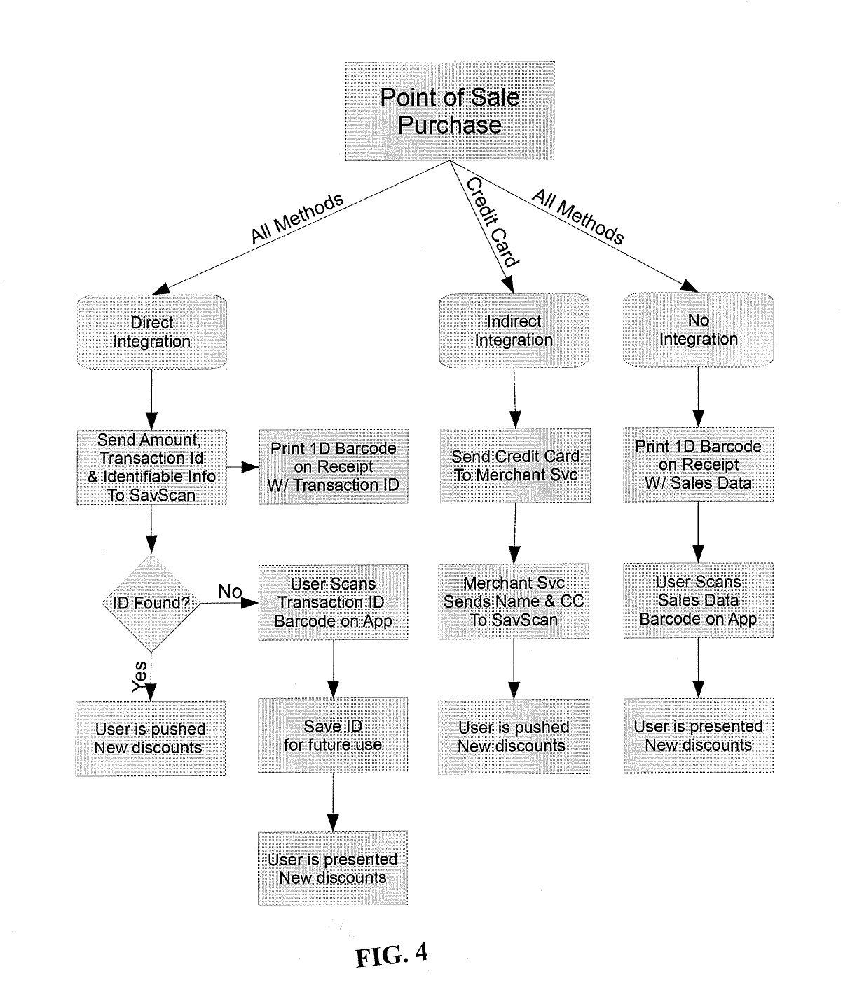

FIG. 4 illustrates an exemplary operation of the present system with separate “all methods” direct integration into the system and no integration as well as registered indirect integration of credit cards into the system as described above. Direct integration permits the greatest flexibility in receiving and being presented with new discounts. Registered credit card users need not integrate with the system to have new discounts pushed to them with simple credit card use. The no integration operation provides a straightforward single time discount and takes pace such as with a cash transaction wherein details of the customer are not provided to the vendor for linkage to the system.

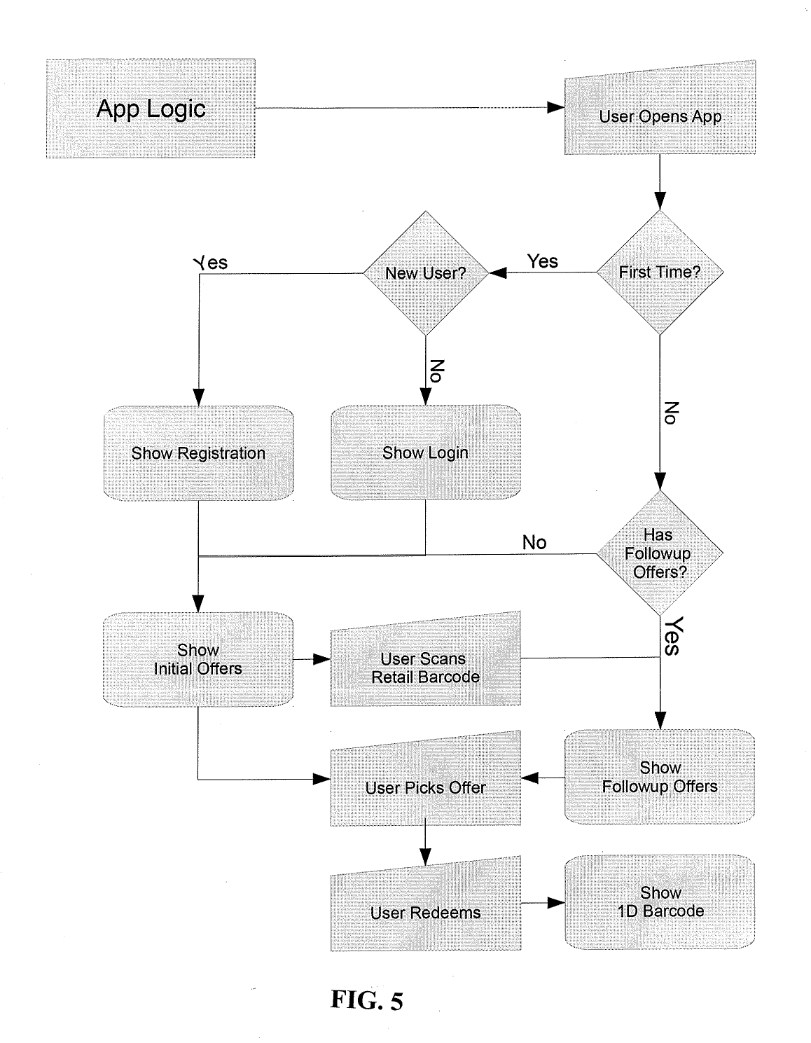

FIG. 5 illustrates an embodiment of the logic used with the controlling app in redeeming coupons and with the providing of follow up orders.

It is understood that the above examples and scenarios are merely exemplary of the present invention with other scenarios and modifications of the system being possible without departing from the scope of the present invention as defined in the following claims.

What is claimed is:

1. A method for increasing store foot traffic in vendor establishments by providing customers with an economic or reward incentive to enter the vendor establishments, comprising the steps of:
a) setting up a system configured to interact with the vendor establishments and customers for the providing of the economic or reward incentives to the customers,
b) signing up of the vendor establishments to be part of a rewards program of the system, with the expectation of increased foot traffic therein and sales,
c) signing up of customers to be part of the rewards program prior to, during or after an initial purchase at one of the vendor establishments with the customer being provided with a coupon/rewards providing app on a mobile device of the customer,
d) the app effecting a transmission to a centralized and controlled server of the system, with details of the sales transaction
e) providing the customers, by use of the app, with at least one virtual coupon for incentive pricing or rewards for related or linked type items or services, with a sales transaction at a first vendor establishment,
f) the system finding the physical location of the customer by the system server whereby the server of the system analyzes the customers sales transaction and provides the virtual coupon or reward benefit for determined commercially related or complementary items at another vendor establishment in proximity to the customers location with the coupon or reward benefit being valid for controlled validity times,
g) accessing, validating and redeeming of the virtual coupon or reward benefit by the customer with an app provided by the system and loaded on a customer's mobile device for the display thereon, and
h) the redeeming of the virtual coupon or reward benefit by a second vendor establishment,
wherein customers are provided with the incentive to frequent multiple vendor establishments.

2. The method of claim 1, wherein the mobile device is a smartphone and location of the customer is effected by means of a GPS location determination as a built-in function of the smartphone.

3. The method of claim 1, wherein the customer utilizes a credit card for the sales transaction, with the credit card being integrated into the system, whereby the transaction locates the position at which the credit card is utilized and thereby the customer's location.

4. The method of claim 1, wherein the virtual coupon comprises indicia readable on the mobile device to validate and redeem the virtual coupon by the second vendor.

5. The method of claim 4, wherein the indicia comprises a bar code scannable from a screen of the mobile device.

6. The method of claim 1, wherein the app is configured to permit the customer to validly transfer or share the virtual coupon.

7. The method of claim 6, wherein the transfer or sharing of the virtual coupon is effected via social media whereby additional customers are signed into the system in order to avail themselves with the virtual coupons with further increase in foot traffic in the vendor establishments.

8. The method of claim 1, wherein a number of potential customers within proximity of a vendor establishment are determined by the physical location determination of the system and made accessible to the vendor establishments with the vendor establishments being provided with the capability of modifying available number and size of virtual coupon discounts based on the number of provided number of potential customers.

9. A method for increasing store foot traffic by providing customers with an economic or reward incentive, wherein, stores, retailers and other actual “brick and mortar” vendors sign up to be part of the rewards program, with the expectation of increased foot traffic and sales and inexpensive focused advertising, the method comprising the steps of.
a) a customer who has signed up for the incentive program of the present invention, and who is shopping at a first retail establishment, is provided with virtual coupons for related or linked type of items at another local retail establishment, with a sales transaction,
b) accessing the coupon via the use of a tangible receipt, having a scannable and unique notation,
c) the customer scans the notation with a smart phone equipped with a scanner and a downloaded transaction rewards app configured to operate to process it for the reward program with:
d) the app effecting a transmission to a centralized and controlled server, with details of the sales transaction,
e) the server or system then analyzes the customers purchase and provides a reward benefit for determined commercially related or complementary items at another local establishment valid for controlled validity times, and
f) downloading the benefit directly on the display of smart phone for scanning therefrom by a redeeming retailer.

10. The method of claim 9, wherein the unique notation is a bar code.

11. The method of claim 10, wherein the benefit is a coupon.
